(19) United States
(12) Patent Application Publication
(10) Pub. No.: US 2020/0180293 A1
(43) Pub. Date: Jun. 11, 2020

(54) PROCESS OF APPLYING A CFRP PATCH ON A STEEL PLATE TO BE FORMED

(71) Applicant: Gestamp Hardtech AB, Lulea (SE)

(72) Inventor: Lars Wikstrom, Sodra Sunderbyn (SE)

(73) Assignee: Gestamp Hardtech AB, Lulea (SE)

(21) Appl. No.: 16/617,623

(22) PCT Filed: May 17, 2018
(86) PCT No.: PCT/EP2018/062845

§ 371 Date: Nov. 27, 2019

(30) Foreign Application Priority Data
Jun. 8, 2017 (SE) 1750723-7

(51) Int. Cl. B32B 38/00; C21D 1/673; B32B 15/18; B32B 15/092; B62D 29/00

(52) U.S. Cl. CPC B32B 38/0036; C21D 1/673; B32B 15/18; B32B 2605/00; B62D 29/005; C21D 2211/001; B32B 2262/106; B32B 15/092

(57) ABSTRACT

A process of producing a composite motor vehicle component, the process comprising the steps of: heating a surface treated steel part (1) to an austenite temperature so as to form austenite in said steel part; forming the steel part to a desired shape, cooling the steel part to a temperature below 500 ° C., applying a patch (2) of a prepreg fibre reinforced polymer to at least a part of said steel part, pressing the applied patch (2) of fibre reinforced polymer into adhesion to steel part (1), and at least partly curing said patch inside said pressing tool.

### TECHNICAL FIELD

The invention relates to a process of applying a part of fibre reinforced polymer to a steel part. Specifically, the invention relates to a process of applying a CFRP patch to a steel plate that is to be formed into a vehicle part.

### BACKGROUND

In the vehicle industry, it is important to provide parts with high ductility, which deform in a foreseeable manner when subjected to a high strain, such as during a collision. It has become conventional in the art to strengthen steel parts by applying fibre reinforced polymers at crucial areas of vehicle parts. This is a favourable way of locally strengthening a product while keeping its weight at a minimum.

Challenges in the art of applying patches of fibre reinforced polymer to a steel plate include achieving a good bonding between the steel part and to keep up the productivity of the operation.

In EP 1 908 669 B1 a process of producing vehicle part is disclosed, in which two parts are joined to each other by means of an adhesive, wherein the second component, typically a fibre reinforced polymer is joined to a steel plate, wherein residual heat from a hot working process of the steel plate is used to generate the adhesive joint between the components.

In order to achieve a good adhesion between the steel part and the fibre reinforced polymer patch and to achieve a precise fit of the reinforced polymer patch there is a desire to apply the fibre reinforced polymer patch as a prepreg and to cure it as it adheres to the steel plate. A problem involved with such a procedure is that curing of a prepreg fibre reinforced polymer normally takes considerable time, which slows down the process.

Hence, there is a desire for a productive process of joining a prepreg fibre reinforced polymer patch to a steel part.

### SUMMARY OF THE INVENTION

It is an object of the present invention to provide an effective process of producing steel parts, specifically for the automotive industry.

This object is achieved by means of a process of producing a composite motor vehicle component, the process comprising the steps of:
heating a surface treated steel part to an austenite temperature so as to form austenite in said steel part;
forming the steel part to a desired shape,
cooling the steel part to a temperature below 500° C.,
applying a prepreg fibre reinforced polymer part to at least a part of said steel part,
pressing the prepreg fibre reinforced polymer part into adhesion to steel part, and at least partly curing said fibre reinforced polymer part.

The invention also relates to a motor vehicle component comprised of a formed steel part and an applied patch of a carbon fibre reinforced polymer, which has been produced by a process as described above.

An advantage of the inventive process is that the production rate may be increased in that the tools for forming and cooling the steel plates are used during a shorter time in that the steel plates may be set to cool down outside of the tools.

Further aspects and advantages of the invention will be apparent from the following description and from the independent claims.

### SHORT DESCRIPTION OF THE DRAWINGS

Below, specific aspects of the invention will be described with reference to the accompanying drawing, of which:

FIG. 1 is a schematic diagram of a process in accordance with a specific aspect of the invention.

### DETAILED DESCRIPTION OF THE INVENTION

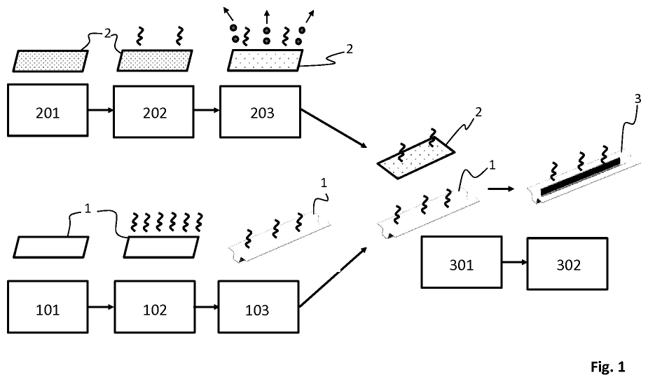

In FIG. 1 a schematic diagram of a process of producing a composite motor vehicle component in accordance with a specific aspect of the invention is shown. The process may be divided into three sub-processes, including a first sub-process comprising a set of steps 101-103 of preparing a steel part for the production of a composite vehicle component; a second set of steps 201-203 of preparing a fibre reinforced polymer part for the same production; and a third set of steps 301-302 of joining said fibre reinforced polymer part to said steel part and forming of said composite vehicle component.

With reference to the lower left part of FIG. 1 the process comprises the steps of heating 101 a steel part 1 to an austenite temperature, typically around 900° C.; allowing the steel part to cool 102 to a temperature of about 600-850° C. and hot-forming said steel part to a desired shape at said temperature. The forming of the steel part is performed in a forming tool. In a subsequent step the hot-formed steel part is cooled 103 to a temperature below 500° C. The cooling is preferably made inside the forming tool in which the steel part was formed.

In parallel to the preparation of the steel part 1, a fibre reinforced polymer part 2 is prepared for subsequent adhesion to the steel part 1. In a first step a fibre reinforced polymer part 2 is provided 201 in an un-cured, pre-preg condition. Pre-preg is to be construed as pre-impregnated composite fibres where a thermoset polymer matrix material, such as epoxy is already present. The thermoset matrix of a pre-preg will need to be cured after it has been given its final shape.

In a subsequent step the fibre reinforced polymer part 2 is heated 202, and in a further subsequent step the trapped air, if any, is removed 203 from between the layers of the fibre reinforced polymer part 2. This step is also performed during heating. The fibre reinforced polymer part 2 preferably has a temperature of about 50-80° C. when subsequently attached to the steel part 1.

The joining of the fibre reinforced polymer part 2 and the steel part 1 is performed in a pressing tool, different from the forming tool in which the steel part is hot formed. The steel part is transferred from the forming tool to the pressing tool over a transfer line. No robot is therefore needed to move the steel part from the forming tool to the pressing tool.

The heated steel part 1 and the heated fibre reinforced polymer part 2 are joined to form a composite part 3 in a tool, typically a forming tool, wherein the heated steel part 1 and the heated fibre reinforced polymer part 2 are introduced 301 into said tool, and wherein heat is provided 302 from the tool in order to at least partially cure the reinforced polymer part 2 inside the heated tool.

In said tool the applied patch of fibre reinforced polymer is pressed into adhesion to the steel part, during heating thereof, whereby said fibre reinforced polymer part 2 is at least partly cured inside said tool. Preferably, the steel part 1 and the prepreg fibre reinforced polymer part 2 are joined without the use of other adhesives than the inherent polymer of the fibre reinforced polymer.

Preferably, no surface treating is performed on the steel part between the step of forming the steel part 1 and the step of applying the fibre reinforced polymer part 2 to a part of said steel part. This is possible as the steel part is either a stainless steel part, a coated steel part, or a pre-treated steel part. The pre-treatment is made to produce a surface on the steel part that is free from loose iron oxide that would otherwise obstruct surface bonding to the fibre reinforced polymer part 2. The heating of the steel part, i.e. step 101, may done in a furnace enclosing with inert environment that is free from oxygen, such that iron oxide will not form during said heating. However, it is more difficult to keep the steel part in an inert environment as it is moved from the furnace to the forming tool.

In many prior art solutions this is solved by performing a surface treatment to the steel as it has cooled down to remove the formed iron oxide prior to the adhesion of the fibre reinforced polymer part to the steel part. Such surface treatment may e.g. include shot peening, blasting or the like. However, such treatment will introduce a further step into the process and slow down the overall process.

According to an aspect of the inventive process the steel component is produced of a steel that has been treated with an oxide scale inhibiting layer. This has the advantage that there will be no need for any surface treatment of the steel part between the heating and forming of the steel part and the adhesion of the fibre reinforced polymer part thereto.

According to one aspect the steel component is produced of a steel that has been covered with an Al—Si layer. As an alternative, the steel component is produced of a steel that has been surface treated, prior to the heating thereto, which surface treatment changes the character of the surface and makes it prone form an oxide of a structure to which the patch of fibre reinforced polymer may attach. This surface treatment typically comprises a 1.5-4 μm thick scale, formed of iron oxides (wüstite, magnetite, and haematite). The steel surface has been chemically pre-treated, which leads to that the scale formed during press hardening is anchored to the steel.

As a further alternative, the steel component may be produced of a stainless steel, wherein no surface treatment will be needed, neither prior to the heating of the steel part, nor after said heating. For most applications the steel part is preferably made of a carbon steel.

During the heating 302 of the composite part 3, during which the reinforced polymer part 2 is at least partially cured, the tool is preferably kept pressed towards the patch of fibre reinforced polymer on the steel part less than 40 seconds, preferably less than 30 seconds. Most preferably the tool is preferably kept pressed less than 20 seconds.

In the prior art it is conventional to upheld a slight pressure and heating in for about 120 seconds to allow the fibre reinforced polymer to cure. As an aspect of the invention it has been tested that the curing may be accelerated by a slight augmentation of the curing temperature. As a consequence, for a typical epoxy, the curing may be performed in about 20-30 seconds instead of the prescribed 120 seconds, whereby the process may be substantially expedited.

In one aspect the prepreg fibre reinforced polymer patch is attached to a portion of the steel part that has been deformed to include at least one bended portion, wherein the prepreg fibre reinforced polymer patch is arranged to cover an inside portion of said at least one bended portion. Such application of a fibre reinforced polymer patch will provide a local strengthening, which is often desired in an area that has undergone a bended or formed part.

The prepreg fibre reinforced polymer patch preferably comprises carbon fibres embedded in epoxy. Preferably, the epoxy is fast hardening epoxy, known as a snap cure epoxy.

The tool in which the prepreg fibre reinforced polymer is at least partly cured is preferably heated to a temperature above 150° C. during pressing of the patch of fibre reinforced polymer to the steel part. The patch of fibre reinforced polymer is attached to the steel part before said steel part has cooled down and still has a temperature of at least 150° C. This is advantageous both as it accelerates the overall process, but also as at takes advantage of the residual heat of the steel part in the curing of the fibre reinforced polymer. The most appropriate temperature of the steel part and the tool is dependent of the type of epoxy used.

Typically, the steel part is allowed to have a higher temperature than the tool at the initiation of the curing process. This is, as indicated above, advantageous as it accelerates the overall process and takes advantage of the residual heat of the steel part in the curing of the fibre reinforced polymer. The steel part will hence be allowed to cool slightly during the curing of the fibre reinforced polymer.

During the heating of the patch of fibre reinforced polymer trapped air between the layers thereof will be allowed to escape. The patch may have a temperature of above 100° C. as it is applied to the steel part.

The steel part may be formed of an austenitic steel that forms a martensitic structure without quenching, and that the process comprises the step of cooling the steel part with the applied patch of carbon fibre reinforced polymer without quenching. Hence, the steel has an alloy that allows creation of a hardened martensitic structure even with a low cooling rate. Cooling in free air is sufficient. This also facilitates the overall process as the steel part may be air hardened, such that the cooling is a less crucial step. Typically, the steel is an air hardened ultra high strength steel (UHSS).

A primary object of the inventive process is to produce a motor vehicle component comprised of a formed steel part and an applied patch of a carbon fibre reinforced polymer, which has been produced by a process as described above.

Above the invention have been described with reference to specific aspects thereof. It is understood by a person skilled in the art that the invention may be varied within the scope of the invention, which is limited only by the following claims.

1. A process of producing a composite motor vehicle component, the process comprising the steps of:
heating a surface treated steel part (1) to an austenite temperature so as to form austenite in said steel part;
forming the steel part (1) to a desired shape,
cooling the steel part (1) to a temperature below 500° C.,
applying a prepreg fibre reinforced polymer part (2) to at least a part of said steel part,
pressing the prepreg fibre reinforced polymer part (2) into adhesion to steel part (1), and at least partly curing said fibre reinforced polymer part (2).

2. The process according to claim 1, wherein the step of forming the steel part (1) to a desired shape is performed inside a forming tool, and wherein the step of applying the prepreg fibre reinforced polymer part (2) to the steel part (1) is performed in a pressing tool different from said forming tool.

3. The process according to claim 2, wherein the steel part is transferred from the forming tool to the pressing tool over a transfer line.

4. The process according to claim 1, wherein no surface treatment is performed on the steel part (2) between the step of forming the steel part and the step of applying the prepreg fibre reinforced polymer part (2) to at least a part of said steel part.

5. The process according to claim 4, wherein the steel part (1) and the prepreg fibre reinforced polymer part (2) are joined without the use of other adhesives than the inherent polymer of the fibre reinforced polymer part (2).

6. The process according to claim 1, wherein the pressing tool is kept pressed towards the fibre reinforced polymer part (2) on the steel part (1) less than 40 seconds, preferably less than 30 seconds.

7. The process according to claim 1, wherein the fibre reinforced polymer part (2) is attached to a portion of the steel part (1) that has been deformed during forming thereof, and wherein the fibre reinforced polymer part (2) is arranged to cover at least apart of said deformed portion of the steel part.

8. The process according to claim 1, wherein the fibre reinforced polymer part (2) comprises carbon fibres embedded in epoxy.

9. The process according to claim 1, wherein said pressing tool is heated to a temperature above 120° C. during pressing of the fibre reinforced polymer part (2) to the steel part (1).

10. The process according to claim 1, wherein the fibre reinforced polymer part (2) is attached to the steel part (1) before said steel part (1) has cooled down and still has a temperature of at least 150° C. when applied to the steel part.

11. The process according to claim 1, wherein the steel part (1) is produced of a steel that has been treated with an oxide scale inhibiting layer.

12. The process according to claim 11, wherein the steel part (1) is produced of a steel that has been covered with an Al—Si layer.

13. The process according to claim 1, wherein the steel part (1) is produced of a steel that has been surface treated so as to form an oxide of a structure to which the fibre reinforced polymer part (2) may attach, the formed oxide structure comprising a 1.5-4 μm thick scale, formed of iron oxides.

14. The process according to claim 1, wherein the steel part (1) is produced of a stainless steel.

15. The process according to claim 1, wherein the steel part (1) is formed of an austenitic steel that forms a martensitic structure by air hardening, and that the process comprises the step of cooling the steel part with the applied fibre reinforced polymer part (2) without rapid quenching.

16. A motor vehicle component comprised of a formed steel part (1) and an applied fibre reinforced polymer part (2), characterised in that it is been produced by a process according to claim 1.

17. The process according to claim 2, wherein no surface treatment is performed on the steel part (2) between the step of forming the steel part and the step of applying the prepreg fibre reinforced polymer part (2) to at least a part of said steel part.

18. The process according to claim 3, wherein no surface treatment is performed on the steel part (2) between the step of forming the steel part and the step of applying the prepreg fibre reinforced polymer part (2) to at least a part of said steel part.

19. The process according to claim 2, wherein the pressing tool is kept pressed towards the fibre reinforced polymer part (2) on the steel part (1) less than 40 seconds, preferably less than 30 seconds.

20. The process according to claim 3, wherein the pressing tool is kept pressed towards the fibre reinforced polymer part (2) on the steel part (1) less than 40 seconds, preferably less than 30 seconds.
